(19) United States
(12) Patent Application Publication
(10) Pub. No.: US 2026/0142961 A1
(43) Pub. Date: May 21, 2026

(54) DYNAMICALLY ADDING AND REMOVING DEVICES IN A CLOUD MANAGED FABRIC VIA A CONTROLLER

(71) Applicant: Cisco Technology, Inc., San Jose, CA (US)

(72) Inventors: Jeffrey Yi Dar Lo, Cupertino, CA (US); Daniel Eric Talayco, Mountain View, CA (US); Robert Stephen Rodgers, Mountain View, CA (US); Kyle Andrew Donald Mestery, Woodbury, MN (US); Thomas John Giuli, Mountain View, CA (US); Sundi Xiao, San Jose, CA (US); Shashidhar Patil, Bengaluru (IN)

(21) Appl. No.: 19/250,032

(22) Filed: Jun. 25, 2025

Related U.S. Application Data
(60) Provisional application No. 63/722,585, filed on Nov. 19, 2024.

(51) Int. Cl. H04L 9/40; H04L 67/141

(52) U.S. Cl. CPC H04L 63/0823; H04L 67/141

(57) ABSTRACT

In some embodiments described herein, methods for dynamically joining a cloud-managed network fabric can include various steps querying at least one adjacent switch, authenticating with a fabric switch, exchanging network proximity data, obtaining an agent session token from a cloud controller, and establishing a secure connection with the cloud controller.

### CROSS-REFERENCE TO RELATED APPLICATION

This application claims the benefit of priority to U.S. Provisional Application No. 63/722,585, filed Nov. 19, 2024, the disclosure of which is incorporated by reference herein in its entirety.

The present disclosure relates to communication networks. More particularly, the present disclosure relates to utilizing the per-link proxy service to dynamically add or remove devices in a cloud managed fabric via a single cable connection.

### BACKGROUND

A network fabric is an interconnected architecture of switches and routers in data centers or enterprise environments, forming a grid that enables efficient, high-speed data transfer across various components such as servers, storage devices, and applications. By linking devices directly or in closely connected layers, a network fabric facilitates seamless communication and reduces bottlenecks. Cloud controllers add another layer of efficiency and centralization to network fabrics, allowing for the remote management of network resources and automation of complex networking tasks. Together, network fabrics and cloud controllers provide a scalable, resilient foundation for managing large volumes of data and diverse applications in modern computing environments.

Integrating artificial intelligence (AI) workloads into network fabrics leverages the low-latency, high-throughput nature of these interconnected systems to support data-heavy and computation-intensive AI tasks. AI applications, such as machine learning, rely on fast, constant access to large data sets and powerful computational resources, which network fabrics facilitate by creating direct, efficient pathways between components. The addition of cloud controllers further enhances the integration of AI into network fabrics by enabling centralized oversight of AI resources, dynamic reallocation of network paths, and load balancing across servers. This alignment allows for real-time processing and data flow, making AI deployments more efficient and capable of handling the demands of advanced machine learning algorithms.

However, undertaking and completing the integration of AI into network fabrics comes with significant challenges. The complexity of configuring AI-specific networking requirements within a data center can be daunting, as AI workloads often need unique configurations for optimal performance. Additionally, handling the massive data transfers and low-latency demands of AI can strain even well-designed network fabrics, leading to potential bottlenecks. Security and data governance concerns are also heightened with AI, as sensitive data is often involved, requiring robust measures to protect and monitor data flows. Finally, scaling the network to accommodate expanding AI demands can lead to compatibility and performance issues as more devices are added, making the integration of AI with network fabrics a challenging endeavor.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network utilizing a cloud controller in accordance with various embodiments of the disclosure;

FIG. 2 is a conceptual illustration of transferring data traffic between devices in a network in accordance with various embodiments of the disclosure;

FIG. 3 is a schematic block diagram of an example architecture for a network fabric in accordance with various embodiments of the disclosure;

FIG. 4 is a conceptual illustration of a network adding a new device in accordance with various embodiments of the disclosure;

FIG. 5 is a conceptual timing diagram for adding a new device in accordance with various embodiments of the disclosure

FIG. 6 is a flowchart illustrating a process for establishing a secure connection with a new network fabric device in accordance with various embodiments of the disclosure;

FIG. 7 is a flowchart illustrating a process for establishing a secure connection with a cloud controller in accordance with various embodiments of the disclosure

FIG. 8 is a flowchart illustrating a process for integrating new devices into a network fabric in accordance with various embodiments of the disclosure; and

FIG. 9 is a conceptual block diagram of a device suitable for configuration with a cloud fabric device onboarding logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In some embodiments, a method of dynamically joining a cloud-managed network fabric includes querying at least one adjacent switch, authenticating with a fabric switch, exchanging network proximity data, obtaining an agent session token from a cloud controller, and establishing a secure connection with the cloud controller.

In some embodiments, a cloud controller within a network fabric includes a processor, at least one network interface controller configured to provide access to the network fabric via a plurality of ports, and a memory communicatively coupled to the processor, wherein the memory includes a cloud fabric device onboarding logic. The logic is configured to receive a proxied onboarding request, validate the authenticity of the onboarding request, issue an agent session token, receive a direct secure connection attempt associated with the agent session token, authenticate a new device associated with the proxied onboarding request, transmit configuration data, and acknowledge full integration into the network fabric.

### EXAMPLE EMBODIMENTS

In response to the problems and issues described herein, particularly those related to the complexities, security concerns, and scaling challenges encountered when adding devices to network fabrics, especially in AI-driven environments, embodiments of the present disclosure provide systems, devices, and methods that may utilize a per-link proxy service to dynamically and securely add or remove devices in a cloud-managed fabric, potentially via a single cable connection. This approach may simplify the expansion of network capacity and capabilities, addressing the potentially tedious and resource-intensive nature of traditional device enrollment processes. The focus may be on enabling a streamlined and automated onboarding experience that enhances both operational efficiency and network security.

In accordance with various embodiments of the disclosure, a Cloud-Managed Network Fabric may refer to a networking architecture where a collection of interconnected network devices, such as switches and routers, typically deployed in data centers or enterprise environments, are centrally monitored, configured, and orchestrated by a cloud-based control system, often termed a cloud controller. This architecture is generally designed for high-speed data transfer, scalability, and resilience, forming a cohesive grid that facilitates efficient communication between various components like servers, storage systems, and applications. The devices within this fabric, including those that may be dynamically added or removed, can be subject to lifecycle management performed via the cloud controller, which acts as a centralized point of intelligence and administration.

The Cloud-Managed Network Fabric paradigm often leverages the capabilities of the cloud controller to simplify network operations, automate complex tasks, and provide a unified view of the network's health and performance. This centralized management approach can be particularly beneficial for deploying and maintaining advanced services and for adapting to changing workload demands, such as those presented by artificial intelligence (AI) applications. By abstracting the underlying physical infrastructure and providing programmable interfaces, the cloud controller enables dynamic resource allocation, policy enforcement, and streamlined provisioning of network services across the fabric. The secure and efficient onboarding of new devices is a critical function within such a fabric, ensuring that expansion or replacement of hardware can occur with minimal disruption and in compliance with established security postures.

A Per-Link Proxy Service, in the context of the present disclosure, may describe a distributed mechanism that enables network devices, particularly those lacking direct pre-configured connectivity to a central cloud controller, to establish communication with that controller for purposes such as initial onboarding and ongoing management. This service can be realized through the deployment of proxy agents, which may be software components running on existing, already integrated, fabric switches. These proxy agents can listen for connection attempts or discovery messages from new devices on their ports and, upon successful local authentication or based on pre-defined policies, relay communications between the new device and the cloud controller, or between the new device and other essential services within the fabric.

The Per-Link Proxy Service can effectively allow each participating switch port to potentially act as an onboarding point for a new device, thereby obviating the need for dedicated management networks or complex pre-staging procedures. A proxy agent, upon detecting a new device, might facilitate initial communication using link-local addressing and then forward the new device's more substantive onboarding requests (e.g., for an agent session token) hop-by-hop through the fabric until a gateway device with direct cloud controller connectivity is reached. This approach not only simplifies the physical deployment of new hardware, potentially enabling onboarding via a single cable connection to an existing switch, but also enhances the flexibility and scalability of the network fabric by providing a ubiquitous mechanism for unconfigured devices to securely join the managed environment.

The Cloud Fabric Device Onboarding Logic may refer to the set of rules, protocols, and software or firmware components, distributed across various entities within the network, that collectively govern and execute the secure, multi-step process of integrating a new network device into the Cloud-Managed Network Fabric. This logic is not necessarily centralized in a single component but rather represents the coordinated intelligence that operates on the new device itself (e.g., as an agent), on existing fabric switches that may assist in the process (e.g., by acting as proxies or local authenticators), and on the central cloud controller that ultimately authorizes and manages the device. Its primary function is to ensure that new devices are discovered, authenticated, configured, and securely connected in an automated and reliable manner.

From the perspective of a new network device seeking to join the fabric, its portion of the Cloud Fabric Device Onboarding Logic may be responsible for initiating discovery actions, such as querying adjacent switches using protocols like LLDP and analyzing MAC OUIs to identify existing fabric members. It may then perform local authentication with an identified fabric switch, potentially using a hardware-anchored identity like a SUDI certificate in a TLS-based gRPC handshake. Following this, the logic may exchange network proximity data (e.g., hop-counts), determine an optimal path to the cloud controller (possibly via a proxy), transmit a connection request to obtain an agent session token, and finally use that token to establish a secure operational channel with the cloud controller.

Conversely, from the viewpoint of the cloud controller, its portion of the Cloud Fabric Device Onboarding Logic may be configured to receive these proxied onboarding requests from new devices via gateway switches. This logic would then validate the authenticity of such requests, which may include authenticating the proxying gateway itself. Upon successful validation, the controller's logic may issue an agent session token back to the new device. Subsequently, when the new device attempts a more direct connection using this token, the controller's logic authenticates the device based on the presented token, transmits necessary configuration data (such as organization-specific policies or security certificates), establishes a secure management channel, and formally acknowledges the device's full integration into the network fabric.

An Agent Session Token may be understood as a unique, often time-limited, digital credential that is issued by the cloud controller to a new network device during the onboarding sequence. The fundamental purpose of this token is to serve as a bearer credential that authorizes the new device, which has successfully passed initial validation stages, to establish a secure and trusted communication channel with the cloud controller and, in some cases, with other legitimately onboarded devices within the same administrative domain or organization within the fabric. It acts as a bridge between an initial, possibly proxied and less trusted interaction, and a subsequent, more privileged and direct operational state.

In many embodiments, the process of obtaining an Agent Session Token can follow after the new device has performed some form of initial local authentication, for example, with an adjacent existing fabric switch that then proxies its request to the cloud controller. The token, therefore, signifies that the cloud controller has acknowledged the new device's request and has provisionally accepted its bid to join the fabric, subject to further interactions using this token. Once obtained, the new network device may present this token in subsequent communication attempts with the cloud controller, particularly when establishing a secure operational channel. Successful validation of this token by the cloud controller allows the device to proceed with the final stages of integration, which can include receiving specific operational configurations, security policies, and organization-specific certificates, thereby transitioning the device to a fully managed state within the fabric.

Hardware-Anchored Secure Device Identity refers to the utilization of secure, often immutable and cryptographically capable, hardware components embedded within a network device to provide a reliable and unfalsifiable root of trust for establishing that device's unique identity. This concept is foundational to achieving a high degree of security in the device onboarding process, as it allows a new device to cryptographically prove its authenticity from the moment it attempts to join the network fabric, mitigating risks associated with counterfeit or unauthorized hardware. Such a hardware anchor ensures that the identity is resistant to software-based attacks or tampering.

Examples of technologies that can provide Hardware-Anchored Secure Device Identity include Secure Unique Device Identifier (SUDI) certificates, which may be compliant with standards like IEEE 802.1AR. These SUDI certificates are often provisioned into a device during its manufacturing process, stored within a secure component like a Trust Anchor Module (TAM), and cryptographically signed by a trusted entity, such as the device vendor. As technology evolves, similar functionalities may also be provided or enhanced by Trusted Platform Modules (TPM), particularly TPM 2.0, which offer a standardized secure cryptoprocessor that can store cryptographic keys, generate digital signatures, and perform other security-critical operations to protect the device's identity and integrity. During the onboarding process, the new device may use its hardware-anchored identity in the initial authentication handshake with an existing fabric switch or when directly or indirectly communicating with the cloud controller, ensuring that all parties can verify the legitimacy of the device before granting it access to the fabric.

Dynamic Single-Connection Onboarding may describe a significant operational advantage and deployment model where a new network device, such as a switch, can be physically introduced into the network fabric and can initiate and complete its entire onboarding process using potentially just a single physical cable connection to an existing, operational fabric switch. This single connection, which could be made to a standard front-facing data port on the existing switch, can be multiplexed to carry all necessary communication flows for the onboarding sequence, thereby simplifying the physical installation process.

This streamlined approach is often achieved by leveraging the connected port on the existing switch to provide both initial discovery and communication capabilities for the new device, as well as enabling access to the Per-Link Proxy Service if the new device requires relayed communication to reach the cloud controller. For instance, the new device might use this single link for Layer 2 discovery protocols (like LLDP), followed by initial Layer 3 communication using IPv6 Link-Local Addresses to interact with an agent on the adjacent switch. The same link can then carry the proxied management traffic for authentication, token acquisition, and configuration download. Once fully onboarded and configured, this same physical connection can then transition to carrying regular data plane traffic for the device's intended networking functions. This method contrasts favorably with many traditional network device deployment procedures that frequently necessitate out-of-band management connections, pre-configuration of dedicated management VLANs on specific ports, or complex pre-staging and manual console configuration for each new device being added to the network, thus offering considerable savings in deployment time and resources.

Resilient Secure Tunneling, exemplified by mechanisms such as “TLS-in-TLS,” may refer to advanced techniques employed within the onboarding process to ensure that a new device can establish and maintain a secure and verifiable communication channel with the cloud controller, even when the network path between them traverses intermediary network devices or security appliances that might be untrusted, misconfigured, or actively interfere with standard secure connection attempts. The primary goal of such resilience mechanisms is to prevent onboarding failures or device isolation that could occur due to problematic network path characteristics that are outside the direct control of the new device or the cloud controller.

This type of tunneling becomes particularly relevant in scenarios where, for example, an outer Transport Layer Security (TLS) connection initiated by the new device is intercepted by a transparent network proxy, such as a corporate firewall performing SSL/TLS inspection using a self-signed or otherwise untrusted certificate, or if the new device has an incorrect system time which could cause legitimate certificates on the path to appear invalid. In such cases, the Resilient Secure Tunneling approach allows for the establishment of an additional, independent, inner TLS tunnel that is encapsulated within the potentially compromised outer connection. This inner tunnel is cryptographically established directly between the new device's onboarding logic and the legitimate cloud controller endpoint. In some embodiments, the trust for this inner tunnel is typically anchored to a certificate or key material specifically controlled by and verifiable between the cloud controller and the device's secure onboarding software or firmware, effectively bypassing the problematic intermediary for the critical security handshake, credential exchange, and configuration data transfer. This can ensure that onboarding communication remains confidential and integral, allowing the process to complete successfully.

IPv6 Link-Local Addressing in Fabric Discovery may refer to the specific application of IPv6 link-local unicast addresses for facilitating initial communication and discovery between a new network device and immediately adjacent devices within the same physical link or Layer 2 broadcast domain, particularly during the bootstrapping phase of the onboarding process. These addresses are typically automatically configured on all IPv6-enabled interfaces and are designed to be unique only on that specific link; they are not routable beyond that local segment.

In the context of a new device joining a Cloud-Managed Network Fabric, an agent (such as the “drake agent”mentioned in some embodiments) on the new device, as well as on existing fabric switches, may utilize these IPv6 Link-Local Addresses to establish direct, peer-to-peer communication before the new device has been assigned a globally routable IP address or has received its full network configuration from the cloud controller. This initial LLA-based communication channel can be crucial for several early-stage onboarding operations. For instance, it may be used to exchange discovery protocol messages (although protocols like LLDP operate at Layer 2, the subsequent interactions they enable might use IP LLA), to initiate a secure handshake for local authentication with an adjacent switch (e.g., the start of a gRPC call which itself runs over IP), or for the new device to send its first proxied onboarding request to an adjacent switch that will then relay it towards the cloud controller. The use of IPv6 Link-Local Addressing thus provides a vital bootstrapping mechanism for network communication, enabling a new, unconfigured device to find and securely interact with its immediate neighbors to kickstart its integration into the managed fabric.

Various embodiments may overcome the need for separate, dedicated management networks by innovatively utilizing the front-facing ports of network devices for both management connectivity and customer data traffic. One aspect of this approach can be the use of a per-link proxy mechanism, which can assist in seamlessly enrolling new devices into an existing fabric. This proxy service may operate on each port of a switch, or on specific configured ports, allowing devices to establish initial communication with adjacent devices. Through these adjacent devices, a new device may ultimately reach a central cloud controller, even if the new device itself lacks a direct, pre-configured connection to the management network or the internet. This method offers first-class network services for onboarding, rather than just simple message relay, ensuring a robust communication path.

The process of adding a new device, such as a new switch, into the cloud-managed fabric may commence with an agent, sometimes referred to as a “drake agent,” operating on the new switch. This agent may employ IPv6 link-local addresses to discover and interact with agents residing on other potentially adjacent switches already part of the fabric. To identify these existing fabric switches, the agent on the new device may be configured to query its front panel ports, analyzing received Link Layer Discovery Protocol (LLDP) data and MAC Organizationally Unique Identifiers (OUIs) from connected peers. Upon identifying a suitable existing fabric switch, a secure initial handshake sequence may be initiated. This handshake could, for example, involve a Transport Layer Security (TLS) based gRPC (Remote Procedure Call) request transmitted from the new switch to the existing fabric switch. Crucially, this request may utilize a Secure Unique Device Identifier (SUDI) certificate, which might be provided by a Trust Anchor Module (TAM) embedded within the new device's hardware, to establish an initial level of trust and perform mutual authentication.

Following a successful local authentication with an existing fabric switch, if the new switch is not itself a gateway device with direct cloud access, it may leverage the authenticated existing switch to act as a proxy. This proxy function enables the new switch to connect to a central cloud service or controller, which might be a specific endpoint. A primary purpose of establishing this proxied connection to the cloud controller can be for the new switch to obtain an agent session token. This token, once issued by the cloud controller and received by the new switch (via the proxy), may serve as a critical credential, authorizing the new switch to establish further, more direct, and secure communications within the fabric and with the cloud controller for full integration. This token-based mechanism ensures a controlled and authenticated entry of new devices into the cloud-managed environment.

The obtained agent session token may subsequently enable the new switch to communicate securely with other switches that are designated as part of the same organization or administrative domain, typically utilizing robust security protocols such as TLS for all subsequent interactions. An important aspect for security and potential multi-tenancy within such a system can be the deployment and enforcement of organization-specific certificates. If a switch is intended to belong to a particular organization, these unique certificates may be pushed down from the cloud controller to the new switch during or immediately after the onboarding procedure. These organization-specific certificates can effectively constrain the switch's communication abilities, preventing it from illicitly interacting with devices or services outside of its authorized organizational perimeter, thereby significantly enhancing overall network integrity, data isolation, and security.

To ensure robust and resilient connectivity to the cloud controller, particularly in diverse user environments where network intermediaries like firewalls or web proxies might be misconfigured or could otherwise interfere with standard TLS handshakes, advanced secure tunneling techniques may be employed. For instance, a “TLS-in-TLS” model may be utilized to bypass problematic intermediaries. If an outer TLS connection attempt by the new device fails verification (e.g., due to an unexpected or self-signed certificate presented by an intermediary transparent proxy, or if the new device's local system clock is significantly incorrect, leading to a misinterpretation of certificate validity periods), an inner TLS tunnel may be established directly with the legitimate cloud controller endpoint. This inner tunnel can be cryptographically rooted to a certificate that is possessed by the cloud controller and is verifiable by the switch (e.g., via a pre-loaded CA certificate in the switch's firmware), allowing the device to connect securely even when the primary external TLS path is compromised or rendered untrustworthy. This capability is significant for preventing devices from becoming “bricked” or permanently disconnected from their management plane due to unforeseen network path issues.

While SUDI certificates can offer a strong hardware-based root of trust for device identity, embodiments of the disclosure may also anticipate and incorporate support for evolving hardware security standards, such as the utilization of Trusted Platform Module (TPM) 2.0 technology in place of, or in addition to, SUDI. Recognizing that some hardware, particularly from various third-party manufacturers, may not include embedded SUDI devices, mechanisms to leverage TPM 2.0 capabilities for secure device identity attestation and onboarding are contemplated. Furthermore, to address potential performance limitations associated with cryptographic operations on certain secure hardware elements, such as the relative slowness that might be encountered if relying on them for every TLS handshake, a custom, lightweight validation protocol may be optionally employed between adjacent devices. This custom protocol could allow for the efficient validation of a self-generated, initially non-verifiable TLS certificate by devices on each side of a link, confirming that it originates from a device possessing a legitimate hardware root of trust (like SUDI or TPM), even in scenarios where immediate cloud connectivity for full certificate chain validation is unavailable.

The described dynamic and secure device onboarding mechanisms may prove particularly advantageous within AI-focused network fabrics, which frequently necessitate rapid scaling and the seamless integration of specialized hardware components such as Graphics Processing Units (GPUs), Data Processing Units (DPUs), and high-performance storage systems. These advanced fabrics may be managed through a centralized cloud platform that can oversee the entire operational lifecycle of the infrastructure, from initial design and deployment to ongoing operations and eventual decommissioning. The capability to add new network resources by simply utilizing their front-facing data ports, often requiring only a single cable connection to an existing fabric switch and without the need for extensive, manual pre-configuration or separate management networks, can significantly streamline the expansion and evolution of critical AI infrastructure. This simplified, highly secure, and automated onboarding process can contribute markedly to the overall efficiency, agility, scalability, and resilience demanded by modern, data-intensive AI workloads and emerging generative AI applications. The design may also promote a more stateless operation for the switches once onboarded, with primary configuration and state being managed by the cloud controller.

In some embodiments, the initial connectivity established by a new device seeking to join the cloud-managed fabric, even when facilitated by a proxy mechanism through an existing fabric switch, may be designed to provide more than simple message relay. This connection can support “first-class network services,” allowing for robust, secure, and relatively rich interactions from the outset. For example, this initial link, though potentially rate-limited or restricted in scope until full authentication and onboarding are complete, may be capable of supporting complex handshake protocols like TLS-based gRPC, the secure exchange of detailed device identifiers such as SUDI certificates, and the negotiation of session parameters. This capability can be contrasted with more constrained onboarding methods seen in some IoT (Internet of Things) contexts, where initial communication might be limited to very small data payloads or highly restricted command sets. By providing a more capable initial networking environment, the onboarding process can be made more secure, flexible, and faster, allowing for comprehensive validation and configuration exchange at an early stage.

Various embodiments of the disclosure may also exhibit significant resilience to variations or even non-standard configurations in physical network topology when a new device is being added. The discovery mechanisms, such as those utilizing Link Layer Discovery Protocol (LLDP) and MAC OUI analysis by an agent on the new device, combined with the hop-by-hop nature of the per-link proxy service, may allow a new device to successfully find a path to the cloud controller even in complex or unintentionally “incorrect” cabling scenarios. For instance, if new switches are connected in a way that might form an unintended physical loop or a daisy-chain rather than a standard hierarchical connection to a gateway, the system may still be able to navigate these paths to establish communication. The ability for any participating switch to potentially act as a proxy and the dynamic nature of path discovery can contribute to the new device's capability to connect to the cloud controller, ensuring that the onboarding process can proceed even if the physical layer is not perfectly aligned with an ideal or pre-defined topology.

Furthermore, while much of the discussion has focused on the dynamic addition of devices, the underlying framework of a cloud-managed fabric with securely onboarded devices may also facilitate the controlled and secure removal or decommissioning of devices. The central cloud controller, having orchestrated the device's entry and maintaining a secure management channel, can also manage its exit. This process may involve the cloud controller instructing the target device to enter a decommissioned state, revoking its operational certificates and tokens, and instructing adjacent fabric switches to cease forwarding traffic to or through the device being removed. The device itself might then securely erase its configuration or perform a factory reset as part of the offboarding process. This centralized control ensures that devices are not just physically unplugged, which could leave security vulnerabilities or disrupt fabric operations, but are gracefully and securely retired from the network fabric, maintaining overall system integrity.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

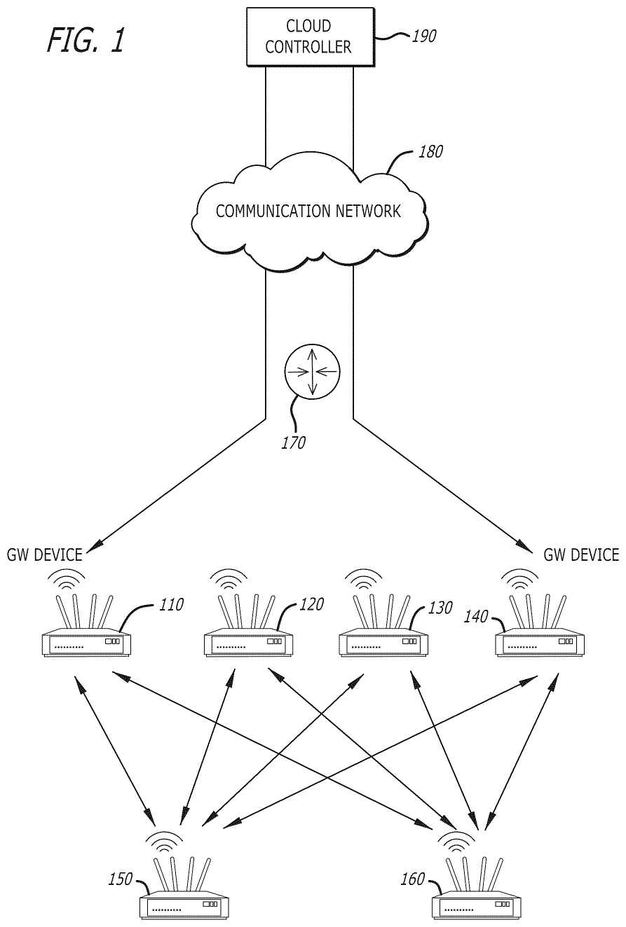

Referring to FIG. 1, a conceptual illustration of a network utilizing a cloud controller in accordance with various embodiments of the disclosure is shown. The depicted network may include a plurality of gateway devices and/or network devices, an element 170 which can function as a router, a communication network 180, and an external cloud controller 190. In many embodiments, specific network devices, such as network devices 110 and 140 (shown in FIG. 1 as gateway devices), can be configured as gateway devices. These network devices 110 and 140 may provide a direct or indirect connection to the external cloud controller 190 by way of the element 170 and the communication network 180. The communication network 180 could represent various networking infrastructures, such as the internet or a private wide area network.

In various embodiments, the external cloud controller 190 may provide centralized management and orchestration capabilities for the network devices 110-160. The cloud controller 190 can communicate with the network devices 110 and 140 through the communication network 180 and the element 170, which may be an edge router. This connectivity can allow the cloud controller 190 to, for example, receive proxied onboarding requests for new devices seeking to join the network fabric, validate the authenticity of such requests, and issue credentials such as an agent session token. The network devices 110 and 140 may function as exit nodes for the local network, relaying information between internal network devices and the external cloud controller 190.

The network devices 110-160 can be interconnected, as suggested by the communication links between them, forming a cohesive network fabric. This fabric structure, encompassing devices like network devices 110-160, may facilitate efficient data transfer and communication within the local environment. In some embodiments, the network devices 110-160 may possess one or more ports, with each port having interfaces or links that connect to other network devices. An agent or a “cloud fabric device onboarding logic” on a network device, as contemplated in the claims, might query at least one adjacent switch through these connections to discover other fabric members.

In certain embodiments, the architecture shown can support dynamic device integration processes. A network device intending to join or operate within this fabric might engage in several steps. For instance, it could authenticate with an existing fabric switch, potentially utilizing a secure unique device identifier certificate. Following authentication, the device could exchange network proximity data, such as hop-count information, with neighboring devices like network device 120 or network device 150 to understand the local topology. This information can be crucial for determining an optimal path or a proxy, possibly through network devices 110 and 140, to obtain an agent session token from the cloud controller 190. Upon receiving such a token, the device could then establish a secure connection with the cloud controller 190.

The establishment of a secure connection allows the cloud controller 190 to transmit configuration data to the device and acknowledge its full integration into the network fabric. This centralized management facilitated by the cloud controller 190, operating over the network structure illustrated in FIG. 1, enables functionalities such as overseeing traffic flow, device discovery, data forwarding, and the secure onboarding of new devices. Network devices, including those not directly connected to a gateway, might forward data hop-by-hop until it reaches a destination, such as a gateway device for communication with the external cloud controller 190. This overall system can support scalable and resilient network operations, particularly for managing a growing number of interconnected devices.

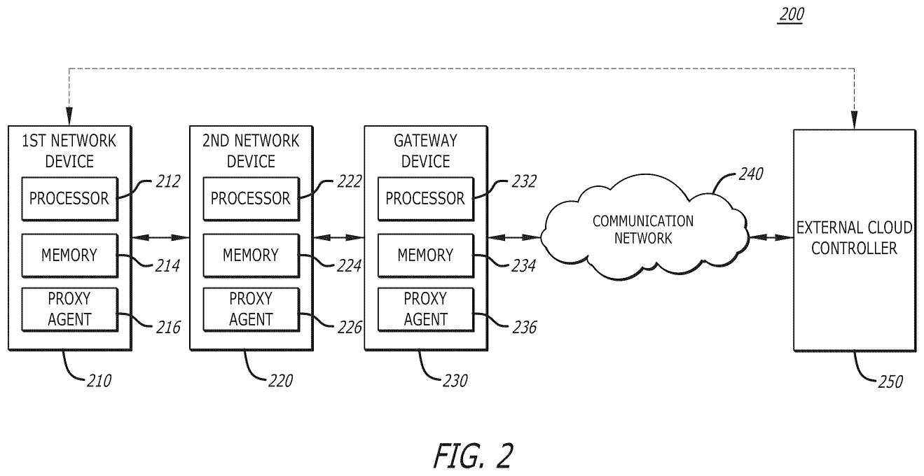

Although a specific embodiment for a network utilizing a cloud controller for carrying out the various steps, processes, methods, and operations described herein is discussed with respect to FIG. 1, any of a variety of systems and/or devices may be utilized in accordance with embodiments of the disclosure. For instance, the element 170 could be a component of network devices 110 or 140 in some deployments, or a standalone edge routing appliance. The elements depicted in FIG. 1 may also be interchangeable with other elements of FIGS. 2-9 as required to realize a particularly desired embodiment.

Referring to FIG. 2, a conceptual illustration of transferring data traffic between devices in a network 200, in accordance with various embodiments of the disclosure is shown. The network 200 may include a first network device 210, a second network device 220, a gateway device 230, a communication network 240, and an external cloud controller 250. In the depicted arrangement, the first network device 210 can be connected to the second network device 220. The second network device 220 may, in turn, be connected to the gateway device 230, and the gateway device 230 can connect to the external cloud controller 250 by way of the communication network 240. Each of the network devices (first network device 210, second network device 220, and gateway device 230) may include a respective processor 212, 222, 232, memory 214, 224, 234, and proxy agents 216, 226, 236.

In many embodiments, the proxy agents 216, 226, and 236 can facilitate the transfer of data traffic, especially when a direct connection to a destination, such as the external cloud controller 250, is not available for a device like the first network device 210. Proxying within such a network fabric can allow data to be relayed from one device to another in a hop-by-hop manner until it reaches its intended recipient. Each of the proxy agents 216, 226, 236 may enable its respective device to act as an intermediary, forwarding traffic. This capability can enhance network resilience and flexibility, as data might be routed through alternative paths if a primary path is congested or unavailable, thereby supporting consistent data flow.

In various embodiments, for a device like the first network device 210 to establish communication with the external cloud controller 250, it might first need to discover a suitable path. The “cloud fabric device onboarding logic,” as contemplated in some claims, could involve processes such as querying adjacent switches and exchanging network proximity data. For instance, the first network device 210, using proxy agents 216, could exchange network proximity data, potentially comprising hop-count information, with the second network device 220. This exchange can help the first network device 210 determine that the second network device 220 is the next hop towards the gateway device 230. Such proximity data might also include device identifiers, device types, or whether a device functions as a gateway or runs a proxy agent.

In certain embodiments, relating to processes like dynamically joining a cloud-managed network fabric, the first network device 210 may need to obtain an agent session token from the external cloud controller 250. To achieve this when lacking a direct connection, the first network device 210 could transmit a connection request to the second network device 220. The proxy agents 226 on the second network device 220 may then forward this connection request to the gateway device 230, potentially using protocols such as an Internet Protocol Link Local Address (IP LLA) or Remote Procedure Calls (RPC). The proxy agent 236 on the gateway device 230 can then forward this proxied onboarding request to the external cloud controller 250.

The external cloud controller 250, upon receiving the proxied request via the communication network 240, may validate the authenticity of the request, potentially based on credentials from the gateway device 230. If validated, the external cloud controller 250 might issue an agent session token. This token can be transmitted back through the gateway device 230 and the second network device 220 to the first network device 210. The first network device 210 could then use this token to establish a secure connection or logical channel with the external cloud controller 250, as indicated by the dashed line. Once this connection is established, the external cloud controller 250 might transmit configuration data. The gateway device 230 can continue to act as a proxy for data traffic between the second network device 220 (and by extension, the first network device 210) and the external cloud controller 250. Similarly, the second network device 220 can proxy traffic between the first network device 210 and the gateway device 230. This proxying mechanism is fundamental for enabling devices without direct cloud access to be managed and to participate in a cloud-managed fabric.

Although a specific embodiment for the network 200 for transferring data traffic between devices for carrying out the various steps, processes, methods, and operations described herein is discussed with respect to FIG. 2, any of a variety of systems and/or processes may be utilized in accordance with embodiments of the disclosure. For example, the proxy agents 216, 226, and 236 could utilize specific lightweight protocols for inter-agent communication to minimize overhead on the network devices. The elements depicted in FIG. 2 may also be interchangeable with other elements of FIG. 1 and FIGS. 3-9 as required to realize a particularly desired embodiment.

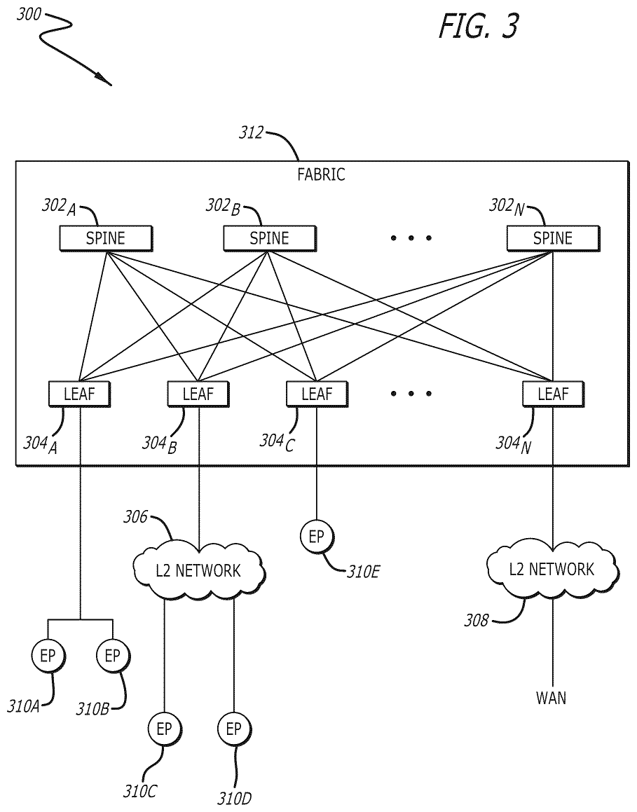

Referring to FIG. 3, a schematic block diagram of an example architecture 300 for a network fabric 312, in accordance with various embodiments of the disclosure is shown. The network fabric 312 may include one or more spine switches 302A, 302B, . . . , 302N (collectively referred to herein as spine switches 302) connected to a leaf switch 304A, along with leaf switch 304B, 304C, . . . , to leaf switch 304N (collectively referred to herein as leaf switches 304) within the network fabric 312. In many embodiments, the network fabric 312 can represent a high-speed, high-bandwidth interconnection system that enables multiple devices to communicate with each other efficiently and reliably. Such a topology may be designed to provide a flexible and scalable infrastructure for data centers, cloud environments, and other network elements.

In various embodiments, the example architecture 300 can employ a leaf-spine design comprising a plurality of spine switches 302 and leaf switches 304. Spine switches 302 may primarily function as Layer 3 (L3) switches within the network fabric 312, although in some cases, the spine switches 302 could also, or alternatively, perform Layer 2 (L2) functionalities. Further, the spine switches 302 may support various capabilities, including, but not limited to, 40 Gbps or 4 Gbps Ethernet speeds. To this end, the spine switches 302 may be configured with one or more high-speed Ethernet ports. In certain embodiments, each such port may also be split to support other speeds; for example, a 40 Gigabit Ethernet port could be split into four 4 Gigabit Ethernet ports, though a variety of other combinations may also be available.

In many embodiments, one or more of the spine switches 302 may be configured to host a proxy function. This proxy function could perform lookups of endpoint address identifiers to locator mappings within a mapping database, perhaps on behalf of leaf switches 304 that might not have such a mapping. The proxy function may achieve this by parsing through a packet, potentially to an encapsulated tenant packet, to ascertain the destination locator address of the tenant. The spine switches 302 may then perform a lookup in their local mapping database to determine the correct locator address for the packet and forward the packet to this locator address, possibly without changing certain fields in the packet's header. Such proxy functionalities could be utilized by a “cloud fabric device onboarding logic” when a new device, for instance, attempts to obtain an agent session token from a remote cloud controller.

In various embodiments, when a packet is received at any given spine switch 302i (where the subscript “i” indicates that this operation may occur at any of the spine switches 302A to 302N), that spine switch 302i may first check if the destination locator address corresponds to a proxy address. If it does, the spine switch 302i may perform the proxy function as previously described. If the destination locator address is not a proxy address, the spine switch 302i may look up the locator in its forwarding table and forward the packet accordingly.

In a number of embodiments, one or more spine switches 302 may connect to multiple leaf switches 304 within the network fabric 312. Leaf switches 304 may feature access ports (which can also be referred to as non-fabric ports) and fabric ports. The fabric ports may provide uplinks from the leaf switches 304 to the spine switches 302, while the access ports may offer connectivity for various devices, hosts, endpoints 310, Virtual Machines (VMs), or external networks to the network fabric 312. A new device connecting to an access port of a leaf switch 304 might initiate an onboarding sequence by having its cloud fabric device onboarding logic query this leaf switch 304 as an adjacent switch.

In more embodiments, leaf switches 304 may reside at the edge of the network fabric 312 and can thus represent the physical network edge. In some cases, the leaf switches 304 may be top-of-rack (“ToR”) switches configured in accordance with a ToR architecture. In other cases, the leaf switches 304 may function as aggregation switches within any particular topology, such as end-of-row (EoR) or middle-of-row (MoR) topologies. The leaf switches 304 may also generally represent aggregation points within the network fabric 312.

In additional embodiments, the leaf switches 304 may be responsible for routing and/or bridging various packets and for applying network policies. In some cases, a leaf switch 304 may perform one or more supplementary functions, such as implementing a mapping cache, sending packets to a proxy function (perhaps on a spine switch 302) when there is a miss in its cache, encapsulating packets, or enforcing ingress or egress policies. Moreover, the leaf switches 304 may incorporate virtual switching functionalities, such as a virtual tunnel endpoint (VTEP) function. An existing leaf switch 304 could also play a role in the onboarding process by assisting a new device to authenticate with the fabric or exchange network proximity data.

In further embodiments, network connectivity within the network fabric 312 may predominantly flow through the leaf switches 304. In this context, the leaf switches 304 may provide servers, resources, endpoints 310, external networks, or VMs with access to the network fabric 312, and may also facilitate connectivity between different leaf switches 304 (typically via the spine switches 302). In some cases, the leaf switches 304 may connect endpoint groups to the network fabric 312 and/or to any external networks. Each endpoint group may connect to the network fabric 312 via one of the leaf switches 304, for example.

Endpoints 310A, 310B, 310C, 310D, and 310E (collectively referred to herein as endpoints 310, and shown as “EP” in FIG. 3) may connect to the network fabric 312 through the leaf switches 304. For example, endpoints 310A and 310B may connect directly to leaf switch 304A, which in turn can connect these endpoints 310A and 310B to the network fabric 312 and potentially to any other of the leaf switches 304 via the spine switches 302. Similarly, endpoints 310E may connect directly to leaf switch 304C, allowing it access to the network fabric 312. In other configurations, endpoints 310C and 310D may connect to leaf switch 304B by way of an L2 network 306. Furthermore, a wide area network (WAN) may connect to the network fabric 312 via leaf switches such as leaf switch 304C and leaf switch 304N through an L3 network 308.

In certain embodiments, the endpoints 310 may comprise any communication device, such as a computer, a server, another switch, or a router. In addition, the endpoints 310 may host virtual workloads, clusters, and applications or services, which can connect with the network fabric 312 or any other device or network, including an external network. Endpoints 310, if they are an intelligent device with onboarding capabilities, might use its own cloud fabric device onboarding logic to authenticate and establish a secure connection within this fabric.

In an AI-focused setup, an example architecture 300, as depicted, may be adapted to meet the unique demands of Artificial Intelligence (AI) workloads, which often require high bandwidth, low latency, and efficient access to distributed compute resources. In such a topology, spine switches 302 may form the core network backbone, connecting to each leaf switch 304, which in turn connects to servers or other AI-related devices. This design may inherently provide scalable, high-throughput connections, and additional enhancements might make it even more suitable for data-intensive AI applications. For example, the architecture may incorporate virtual tunnel endpoints (VTEPs) at the leaf switch 304 layer, which can allow virtualized environments to connect seamlessly across the physical infrastructure. These VTEPs may establish overlay networks to separate AI traffic from other types of traffic, which may help ensure that AI data flows remain isolated, secure, and prioritized for rapid processing.

Furthermore, virtual switching functionalities may be leveraged within the network fabric 312 to dynamically allocate network paths based on AI workload requirements. In an AI-focused environment, certain paths within the example architecture 300 may be optimized specifically for data-heavy transfers, for instance, between GPU clusters or data lakes, which may allow AI models to access large datasets without experiencing significant bottlenecks. A cloud controller managing such a network fabric 312 may play a role in this by continuously monitoring traffic patterns and adjusting these virtualized paths to balance load, reduce latency, and ensure that critical AI processes receive prioritized access to network resources. The processes for dynamically adding new AI compute resources would rely on an efficient onboarding mechanism, such as that provided by a cloud fabric device onboarding logic, to securely establish connections and integrate these resources into the fabric.

Although a specific embodiment for an example architecture 300 for a network fabric 312 is described above with respect to FIG. 3, any of a variety of systems and/or processes may be utilized in accordance with embodiments of the disclosure. For example, the L2 network 306 or L3 network 308 could represent connections to specialized storage networks or other critical infrastructure that integrates with the network fabric 312. The elements depicted in FIG. 3 may also be interchangeable with other elements of FIGS. 1-2 and FIGS. 4-9 as required to realize a particularly desired embodiment.

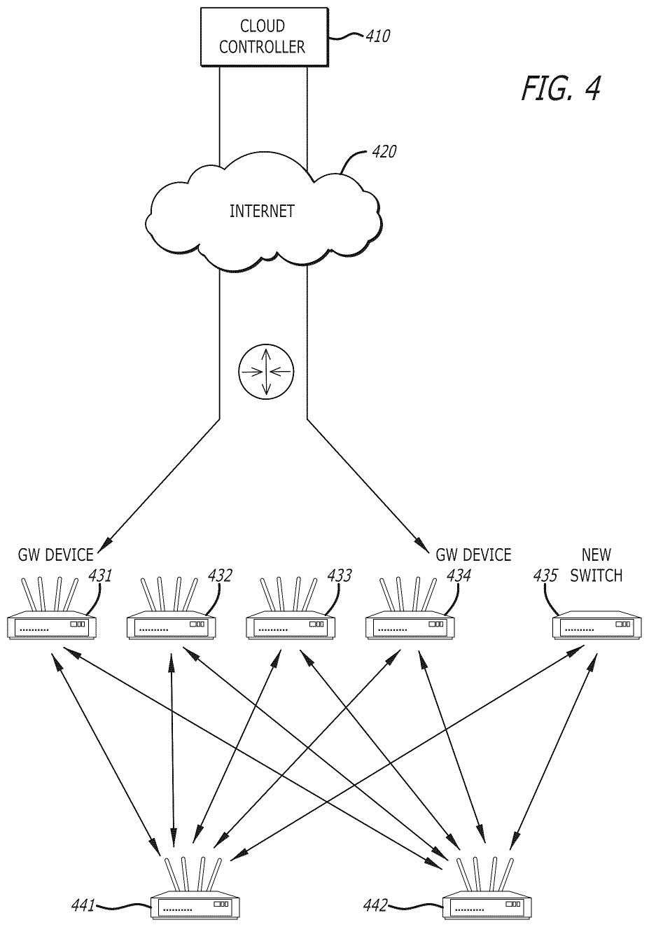

Referring to FIG. 4, a conceptual illustration of a network adding a new device in accordance with various embodiments of the disclosure is shown. The depicted network architecture may include a cloud controller 410, which can be accessible via a communication medium such as the internet 420. Several interconnected network devices may form an existing network fabric. Among these, network device 431 and network device 434 may be configured as gateway (GW) devices, serving as exit points from the local network fabric to the cloud controller 410 through the internet 420. A new switch 435 is also illustrated on the far right, representing a device that is being integrated or is intended for integration into this existing fabric structure.

In many embodiments, the existing switches within the fabric, such as network device 431, switch 432, switch 433, network device 434, switch 441, and switch 442, may be linked by multiple paths, which can promote resilient and efficient data flow. The arrows between these switches can represent direct data paths, allowing traffic to traverse the network fabric via various routes, potentially providing redundancy and improving load distribution. As noted in the figure, each switch in such a network may run an agent. This agent can be configured to proxy traffic, for instance, through an IPv6 link-local address, enabling communication with adjacent devices and, ultimately, with the cloud controller 410. This proxying functionality on each port may allow the switches to relay information hop-by-hop across the fabric until it reaches one of the network device 431 or 434, which can then connect to the cloud controller 410.

In various embodiments, when the new switch 435 is introduced to be added to the network fabric, a “cloud fabric device onboarding logic” (as contemplated in claim 1, for instance, residing on the new switch 435) may initiate the integration process. This process could begin when the new switch 435 is physically connected to one or more of the existing switches in the fabric (e.g., network device 431, network device 434, or other switches like switch 441 or switch 442). The logic on the new switch 435 may then query at least one adjacent switch to discover the fabric and its members. This query could involve analyzing Link Layer Discovery Protocol (LLDP) data or MAC Organizationally Unique Identifiers (OUIs) from the connected adjacent switches.

In certain embodiments, following the initial discovery, the cloud fabric device onboarding logic on the new switch 435 may proceed to authenticate with a discovered fabric switch. This authentication step could involve initiating a secure handshake and might utilize a secure unique device identifier (SUDI) certificate associated with the new switch 435 to establish a trusted relationship with the existing fabric switch. Once authenticated locally, the new switch 435 may then exchange network proximity data, which could comprise hop-count information, with the adjacent fabric switch or other discovered devices. This exchange helps the new switch 435 to understand its position within the fabric topology and to determine an optimal proxy path if it needs to communicate with the cloud controller 410 indirectly.

In some embodiments, if the new switch 435 requires communication with the cloud controller 410 to, for example, obtain an agent session token, it may use an existing fabric switch, such as network device 431 or network device 434, as a proxy. The new switch 435 could transmit a cloud controller connection request via this determined optimal proxy path. The agent on the proxying switch would then relay this request to the cloud controller 410. The cloud controller 410, potentially after validating the request (which could involve its own cloud fabric device onboarding logic as per claim 22), may issue an agent session token back to the new switch 435 via the proxy.

In further embodiments, upon obtaining the agent session token, the new switch 435 may then establish a secure connection with the cloud controller 410. This connection could be a direct secure communication channel or a continually proxied secure connection, and it may be achieved using the agent session token for authentication. Through this secure connection, the cloud controller 410 can transmit configuration data and acknowledge the full integration of the new switch 435 into the network fabric. This overall process, supported by the architecture in FIG. 4, can facilitate centralized management by the cloud controller 410, even for switches that do not have a direct link to it, and emphasizes both scalability and resilience for dynamic growth and robust connectivity within the network fabric.

Although a specific embodiment for a network adding a new device suitable for configuration with the various steps, processes, methods, and operations described herein is discussed with respect to FIG. 4, any of a variety of systems and/or processes may be utilized in accordance with embodiments of the disclosure. For example, the new switch 435 could be a leaf switch being added to a spine-leaf architecture, or a spine switch itself if the fabric is being scaled at the core. The elements depicted in FIG. 4 may also be interchangeable with other elements of FIGS. 1-3 and FIGS. 5-9 as required to realize a particularly desired embodiment.

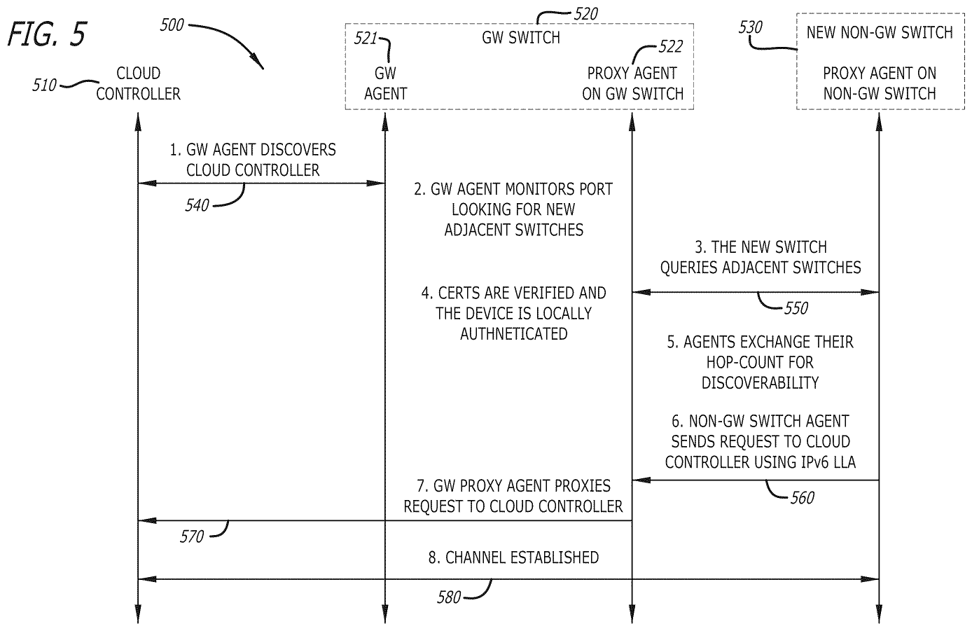

Referring to FIG. 5, a conceptual timing diagram illustrating a process 500 for adding a new device to a network fabric, in accordance with various embodiments of the disclosure is shown. This timing diagram depicts a sequence of interactions involving a Cloud Controller 510, an existing Gateway Switch (GW Switch 520), which can include a GW Agent 521 and a Proxy Agent on GW Switch 522), and a New non-GW Switch 530 (which includes a Proxy Agent on non-GW Switch 540). These interactions facilitate the integration of the New non-GW Switch 530 into the existing network architecture and establish communication with the Cloud Controller 510.

In many embodiments, the process 500 may begin with preparatory steps by the existing infrastructure. For instance, as shown in Step 1, the GW Agent 521 on the GW Switch 520 may discover the Cloud Controller 510. Following this discovery, as depicted in Step 2, the GW Agent 521 may continuously monitor its ports to detect any new adjacent switches, thereby keeping the network fabric ready for expansion. The Proxy Agent on GW Switch 522 may subsequently play a role in facilitating communication for new devices.

In various embodiments, when the New non-GW Switch 530 is physically connected to the network, its Proxy Agent on non-GW Switch 540 may initiate an onboarding process. As illustrated in Step 3 (associated with interaction 550), the New non-GW Switch 530, via its Proxy Agent on non-GW Switch 540, may query adjacent switches, such as the GW Switch 520 (specifically interacting with its Proxy Agent on GW Switch 522). This query, part of a “cloud fabric device onboarding logic,” allows the New non-GW Switch 530 to gather information from nearby switches. Subsequently, as shown in Step 4, certificates may be exchanged and verified between the Proxy Agent on GW Switch 522 and the Proxy Agent on non-GW Switch 540, and the New non-GW Switch 530 may undergo local authentication with the fabric switch (GW Switch 520), which can help ensure it is a trusted addition to the network.

In certain embodiments, after local authentication, the respective agents may exchange network proximity data. As depicted in Step 5, the Proxy Agent on non-GW Switch 540 and the Proxy Agent on GW Switch 522 may exchange their hop-count information. This exchange can help the devices assess relative distances and connectivity within the network, facilitating discoverability and the determination of an optimal proxy path for the New non-GW Switch 530 to reach the Cloud Controller 510.

In some embodiments, after the hop-count exchange, the Proxy Agent on non-GW Switch 540 may send a request destined for the Cloud Controller 510. As shown in Step 6 (associated with interaction 560), the Proxy Agent on non-GW Switch 540 sends this request, potentially to obtain an agent session token, using IPv6 Link-Local Addressing (LLA) and forwards it to the Proxy Agent on GW Switch 522. The Proxy Agent on GW Switch 522 then, as illustrated in Step 7 (associated with interaction 570), may proxy this request to the Cloud Controller 510. This action enables the New non-GW Switch 530, which lacks direct cloud connectivity, to reach the Cloud Controller 510 indirectly. The Cloud Controller 510 may then validate the request and issue an agent session token.

In further embodiments, with the assistance of the Proxy Agent on GW Switch 522, a communication channel may be established. As depicted in Step 8 (associated with interaction 580), this channel is established between the New non-GW Switch 530 and the Cloud Controller 510. This secure connection, potentially established using the obtained agent session token, allows the Cloud Controller 510 to oversee and manage the New non-GW Switch 530, transmit configuration data, and acknowledge its full integration into the network fabric. This sequence of operations illustrates a controlled and secure method for adding new devices, where existing gateway devices and their proxy agents can ensure reliable onboarding and integration into a centralized network management system.

Although a specific embodiment for a conceptual timing diagram for adding a new device, illustrating process 500, is discussed with respect to FIG. 5, any of a variety of systems and/or processes may be utilized in accordance with embodiments of the disclosure. For example, the IPv6 Link-Local Addressing (LLA) mentioned in the interaction associated with Step 6 may be used for initial communication before full IP addresses are assigned or discovered within the fabric. The elements depicted in FIG. 5 may also be interchangeable with other elements of FIGS. 1-4 and FIGS. 6-9 as required to realize a particularly desired embodiment.

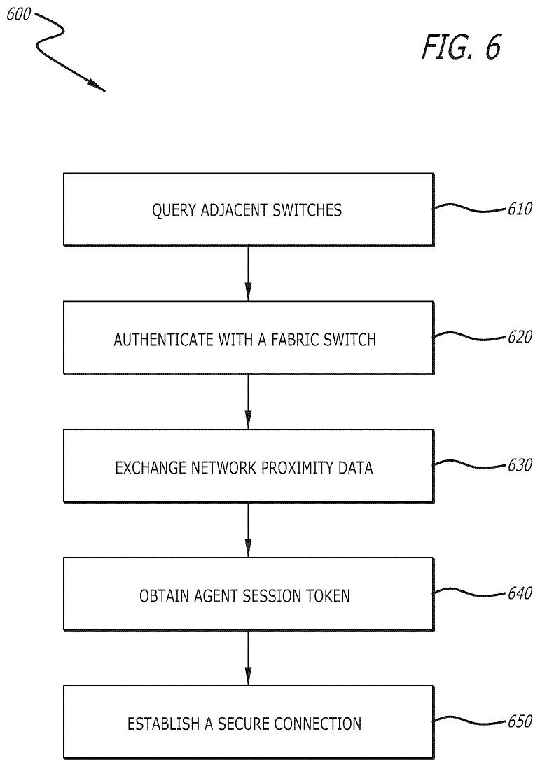

Referring to FIG. 6, a flowchart illustrating a process 600 for establishing a secure connection with a new network fabric device in accordance with various embodiments of the disclosure is shown. In many embodiments, the process 600 can query adjacent switches (block 610). This querying action can be initiated automatically by an agent on the new network device upon detecting a physical connection to the network. For instance, the agent may begin to scan its front panel ports to actively seek out existing members of the fabric. In other instances, the querying of adjacent switches might be triggered by a specific command received from a provisioning system or a user action, and the query itself could utilize various discovery protocols, such as Link Layer Discovery Protocol (LLDP) or involve analyzing MAC Organizationally Unique Identifiers (OUIs) from connected devices.

In a number of embodiments, the process 600 can authenticate with a fabric switch (block 620). This authentication can involve a mutual exchange of credentials where the new device presents its identity, and the fabric switch also verifies its authenticity as part of the established fabric. For example, the authentication process may include initiating a secure handshake mechanism, such as a Transport Layer Security (TLS) based gRPC request. It is contemplated that the authentication can utilize a hardware-based root of trust, such as a secure unique device identifier (SUDI) certificate embedded in the new network device, to prove its identity to the fabric switch.

In more embodiments, the process 600 can exchange network proximity data (block 630). The exchanged network proximity data may comprise hop-count information, which can indicate the number of network “hops” or steps between the new device and other devices or specific points in the network, like a gateway device. For instance, this proximity data could be utilized by the new device to determine the closest or most optimal gateway device or an existing fabric switch that can act as a proxy for communication with a cloud controller. The data might also include other relevant details such as device identifiers or the capabilities of neighboring devices.

In further embodiments, the process 600 can obtain an agent session token (block 640). The agent session token is typically provided by a central cloud controller after the new device, possibly through a proxy path determined from network proximity data, has successfully communicated its onboarding request and has been validated by the controller. It is contemplated that obtaining the token might involve the new device sending a specific request, containing its authenticated identity established in a prior phase, to the cloud controller. This token can then serve as a temporary credential for subsequent secure interactions and authorization.

In additional embodiments, the process 600 can establish a secure connection (block 650). This secure connection is often established between the new network device and the cloud controller, utilizing the previously obtained agent session token as part of the authentication for this connection. For example, the secure connection might be a direct Transport Layer Security (TLS) communication channel if the device has direct reachability or can establish one post-token acquisition. Alternatively, if direct reachability is not consistently available or desired, the secure connection could be a continually proxied secure connection maintained through an established gateway or fabric switch. This connection allows for the secure transmission of configuration data from the cloud controller and for the ongoing management of the device within the fabric.

Although a specific embodiment for a process 600 for establishing a secure connection with a new network fabric device suitable for carrying out the various steps, processes, methods, and operations described herein is discussed with respect to FIG. 6, any of a variety of systems and/or processes may be utilized in accordance with embodiments of the disclosure. For example, the sequence of operations in process 600 could be implemented as part of an automated zero-touch provisioning (ZTP) workflow initiated when a new device is powered on within the network environment. The elements depicted in FIG. 6 may also be interchangeable with other elements of FIGS. 1-5 and FIGS. 7-9 as required to realize a particularly desired embodiment.

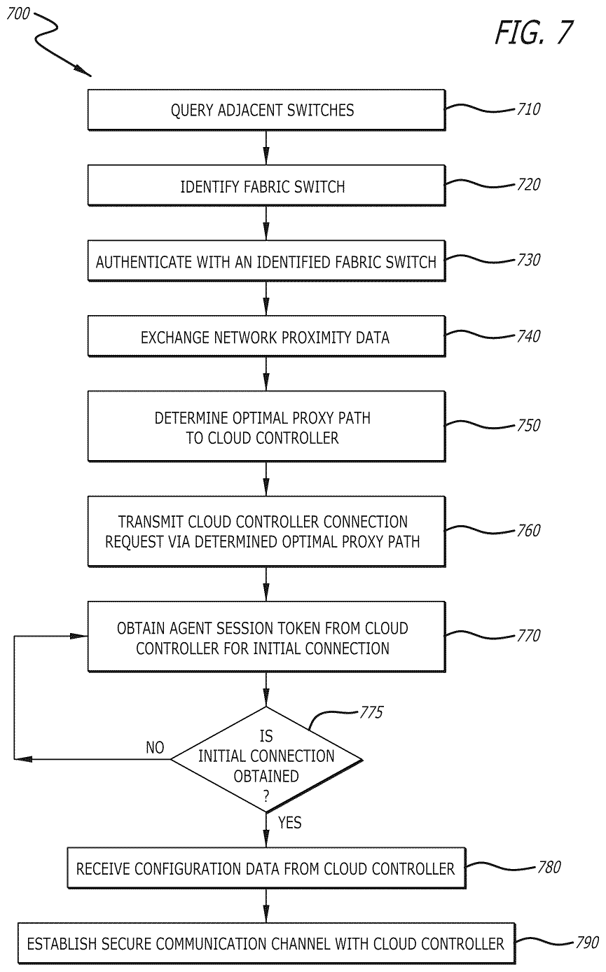

Referring to FIG. 7, a flowchart illustrating a process 700 for establishing a secure connection with a cloud controller in accordance with various embodiments of the disclosure is shown. In many embodiments, the process 700 can query adjacent switches (block 710). This querying action may be automatically initiated by an agent on a new network device, for instance, upon the device detecting a physical connection to the network. The agent itself may initialize this query. It is contemplated that the query could involve the use of various discovery protocols, such as analyzing Link Layer Discovery Protocol (LLDP) data or MAC Organizationally Unique Identifiers (OUIs) from any connected devices, to gather information about the local network environment.

In a number of embodiments, the process 700 can identify a fabric switch (block 720). The identification of a fabric switch may be based on specific signatures, capabilities, or responses received from the switches that were queried in a preceding operation. For example, a device may analyze the gathered information to determine if an adjacent switch is part of the intended cloud-managed fabric. In some instances, this identification of a fabric switch occurs prior to attempting to authenticate with that fabric switch, ensuring that authentication efforts are directed towards legitimate fabric members.

In more embodiments, the process 700 can authenticate with an identified fabric switch (block 730). This authentication can be a mutual process where both the new device and the identified fabric switch verify each other's credentials, potentially involving the initiation of a secure handshake. It is contemplated that this authentication can utilize a secure unique device identifier (SUDI) certificate associated with the new device to prove its identity. Successfully authenticating with the fabric switch may be a prerequisite before exchanging more detailed network proximity data.

In further embodiments, the process 700 can exchange network proximity data (block 740). The exchanged network proximity data may comprise hop-count information, which can indicate the number of network hops or logical distance to other network entities. For example, this data can assist the new device in building a local view of the network topology. This information can then be used to make informed decisions about routing or selecting a proxy for communication with a remote cloud controller.

In additional embodiments, the process 700 can determine an optimal proxy path to a cloud controller (block 750). This determination may be made prior to attempting to obtain an agent session token from the cloud controller, particularly if the new device does not have direct connectivity. For instance, the selection of an optimal proxy path could be based on criteria such as the shortest hop-count to a known gateway device or another fabric switch capable of acting as a proxy. The process might also involve evaluating other factors like the reported capabilities or load of potential proxy switches, if such information was part of the exchanged network proximity data.

In still more embodiments, the process 700 can transmit a cloud controller connection request via the determined optimal proxy path (block 760). This connection request may be specifically formatted for the cloud controller and could be intended to initiate the process of obtaining an agent session token. For example, the transmission to the first hop of the proxy path might utilize a protocol such as IPv6 Link-Local Addressing (LLA). This step follows the determination of the proxy path and precedes the actual token acquisition.

In yet further embodiments, the process 700 can obtain an agent session token from the cloud controller for an initial connection (block 770). This token typically serves as a credential that authorizes the new device to the cloud controller. For instance, the token may be received via the same proxy path that was used to transmit the connection request. The act of obtaining this agent session token may result in an initial connection being established with the cloud controller.

In numerous embodiments, the process 700 can determine if an initial connection has been obtained (block 775). This determination may verify whether the previously obtained agent session token has successfully facilitated at least a preliminary communication link with the cloud controller. If an initial connection has not been obtained, then the process 700 may once again attempt to obtain an agent session token from the cloud controller for an initial connection (block 770).

However, if it is determined that an initial connection has been obtained, then the process 700 may proceed to receive configuration data from the cloud controller (block 780). For example, upon obtaining this initial connection, the new device may receive configuration data from the cloud controller. This configuration data can include organization-specific policies, security certificates, or network parameters essential for the new device to align its operations with the specific fabric it is joining.

In some embodiments, the process 700 can establish a secure communication channel with the cloud controller (block 790). This channel may be established using the previously obtained agent session token and any configuration data or certificates received from the cloud controller. For instance, this could be a Transport Layer Security (TLS) channel. This secure communication channel can then be used for ongoing management communications, telemetry reporting, and the execution of further operational commands between the new device and the cloud controller, signifying its full integration and readiness for operation within the managed fabric.

Although a specific embodiment for a process 700 for establishing a secure connection with a cloud controller suitable for carrying out the various steps, processes, methods, and operations described herein is discussed with respect to FIG. 7, any of a variety of systems and/or processes may be utilized in accordance with embodiments of the disclosure. For example, the determination of an optimal proxy path in the operations associated could involve a dynamic algorithm that also considers the current load or responsiveness of potential proxy switches if that information is available through the exchanged network proximity data. The elements depicted in FIG. 7 may also be interchangeable with other elements of FIGS. 1-6 and FIGS. 8-9 as required to realize a particularly desired embodiment.

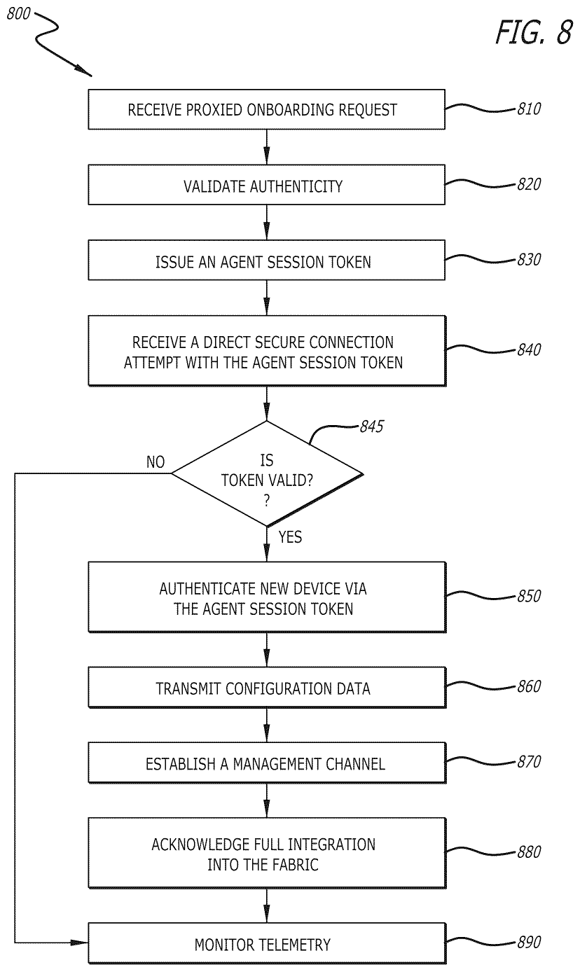

Referring to FIG. 8, a flowchart illustrating a process 800 for integrating new devices into a network fabric, in accordance with various embodiments of the disclosure is shown. This process typically outlines operations that may be performed by a cloud controller. In many embodiments, the process 800 can receive a proxied onboarding request (block 810). This request may originate from a new network device attempting to join the fabric and can be relayed by an existing gateway device or another fabric switch acting as a proxy. For instance, the request might contain identifiers for both the new device and the proxying switch, along with an indication that the new device is seeking authorization.

In a number of embodiments, the process 800 can validate authenticity (block 820). The validation of authenticity may involve verifying the credentials of the proxying gateway switch that relayed the onboarding request to ensure it is a trusted member of the fabric. It is contemplated that this can also include preliminary checks on any information provided about the new device within the request to ascertain the legitimacy of the onboarding attempt before issuing any credentials.

In more embodiments, the process 800 can issue an agent session token (block 830). This token may be a temporary, unique credential generated by the cloud controller upon successful initial validation of the proxied onboarding request. For example, this agent session token can be transmitted back to the new network device, typically via the same proxy path through which the request was received, and is intended to authorize the new device for a subsequent, more direct connection attempt.

In further embodiments, the process 800 can receive a direct secure connection attempt with the agent session token (block 840). This connection attempt is generally expected from the new network device itself after it has received the agent session token. For instance, the new device might initiate a Transport Layer Security (TLS) connection, presenting the received token as part of the handshake to prove its prior authorization by the cloud controller.

In additional embodiments, the process 800 can determine if the received agent session token is valid (block 845). This determination verifies whether the token presented by the new device in its connection attempt is authentic, unexpired, and matches a token previously issued by the cloud controller. If the token is determined not to be valid, then the process 800 may attempt to issue an agent session token again (block 830), or alternatively, the connection attempt could be rejected.

However, if it is determined that the token is valid, then the process 800 may proceed to authenticate the new device via the agent session token (block 850). For example, this authentication step can formally confirm that the new device is the legitimate holder and recipient of the validated token. Successfully authenticating the new device via the agent session token can transition the device from a provisionally authorized state to a fully authenticated state recognized by the cloud controller.

In still more embodiments, the process 800 can transmit configuration data (block 860). Once the new device is authenticated, the cloud controller may send it necessary configuration information. For instance, this data can include organization-specific policies, network parameters for operation within the fabric, security certificates to enable secure communication with other fabric members, or even software updates. This ensures the new device aligns with the fabric's operational and security standards.

In yet further embodiments, the process 800 can establish a management channel (block 870). This involves setting up a persistent and secure communication channel between the cloud controller and the newly integrated and configured device. For example, this management channel can be used for ongoing monitoring, sending control commands, and delivering future updates to the device. In some configurations, the cloud fabric device onboarding logic further comprises establishing this management channel prior to acknowledging full integration into the network fabric.

In still additional embodiments, the process 800 can acknowledge full integration into the fabric (block 880). This acknowledgment may be an internal state update within the cloud controller, signifying that the new device is now a fully operational and managed member of the network fabric. It is contemplated that this could also involve updating a central inventory system or sending a confirmation status that is visible to network administrators.

In numerous embodiments, the process 800 can monitor telemetry (block 890). After the new device is fully integrated, the cloud controller may begin to continuously receive and process telemetry data from it. For instance, this telemetry can include performance metrics, device health status, security event logs, and other operational data. This ongoing monitoring allows the cloud controller to ensure the device's proper functioning, maintain the overall health of the fabric, and proactively identify or address any potential issues.

Although a specific embodiment for a process 800 for integrating new devices into a network fabric suitable for carrying out the various steps, processes, methods, and operations described herein is discussed with respect to FIG. 8, any of a variety of systems and/or processes may be utilized in accordance with embodiments of the disclosure. For example, the validation of authenticity in the operations associated with block 820 could involve checking the proxying gateway's digital certificate against a trusted certificate authority list maintained by the cloud controller. The elements depicted in FIG. 8 may also be interchangeable with other elements of FIGS. 1-7 and FIG. 9 as required to realize a particularly desired embodiment.

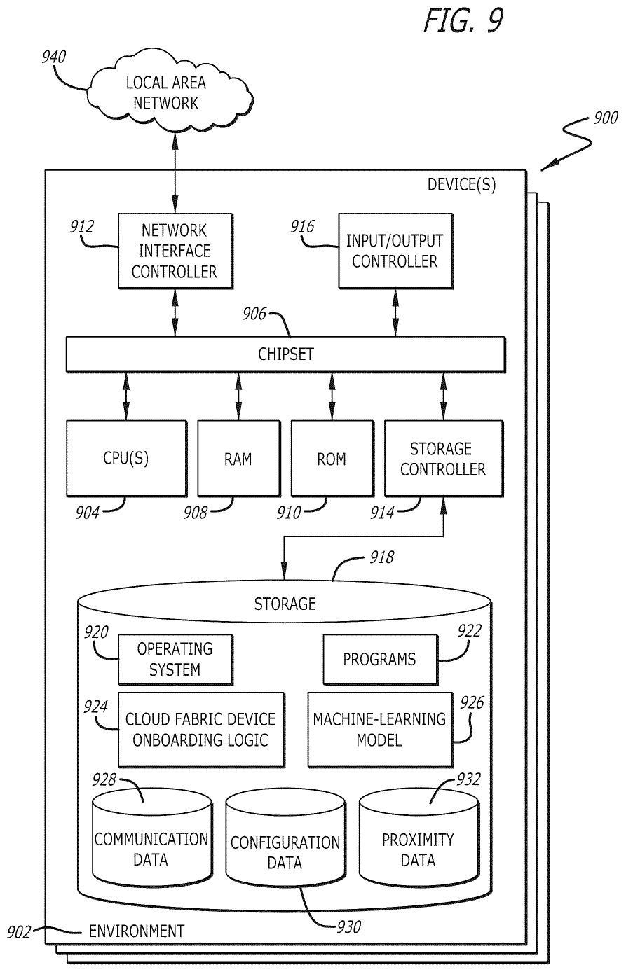

Referring to FIG. 9, a conceptual block diagram of a device 900 suitable for configuration with a cloud fabric device onboarding logic 924, in accordance with various embodiments of the disclosure is shown. The embodiment of the conceptual block diagram depicted in FIG. 9 may illustrate a conventional server, computer, workstation, desktop computer, laptop, tablet, network appliance, e-reader, smartphone, or other computing device, and may be utilized to execute any of the application and/or logic components presented herein. The embodiment of the conceptual block diagram depicted in FIG. 9 may also illustrate an access point, a switch, or a router, or even a cloud controller component, in accordance with various embodiments of the disclosure. The device 900 may, in many non-limiting examples, correspond to physical devices or to virtual resources described herein.

In many embodiments, the device 900 may include an environment 902 such as a baseboard or “motherboard,” which in physical embodiments may be configured as a printed circuit board with a multitude of components or devices connected by way of a system bus or other electrical communication paths. Conceptually, in virtualized embodiments, the environment 902 may represent a virtual environment that encompasses and executes the remaining components and resources of the device 900. In more embodiments, processor(s) 904, such as, but not limited to, central processing units (“CPUs”), may be configured to operate in conjunction with a chipset 906. The processor(s) 904 may be standard programmable CPUs that perform arithmetic and logical operations necessary for the operation of the device 900.

In a number of embodiments, the processor(s) 904 may perform one or more operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 may provide an interface to a random-access memory (RAM 908), which may be used as the main memory in the device 900 in some embodiments. The chipset 906 may further be configured to provide an interface to a computer-readable storage medium such as a read-only memory (ROM 910) or non-volatile RAM (NVRAM) for storing basic routines that may help with various tasks such as, but not limited to, starting up the device 900 and/or transferring information between the various components and devices. The ROM 910 or NVRAM may also store other application components necessary for the operation of the device 900 in accordance with various embodiments described herein.

Additional embodiments of the device 900 may be configured to operate in a networked environment using logical connections to remote computing devices and computer systems through a network, such as the network 940. The chipset 906 may include functionality for providing network connectivity through a network interface controller (NIC 912), which may comprise one or more Ethernet adapters or similar components providing access to a plurality of ports. The NIC 912 may be capable of connecting the device 900 to other devices over the network 940. It is contemplated that a NIC 912 or multiple may be present in the device 900, connecting the device to other types of networks and remote systems.

In further embodiments, the device 900 may be connected to a storage 918 that provides non-volatile storage for data accessible by the device 900. The storage 918 may, for instance, store an operating system 920, applications 922, communication data 928, configuration data 930, and proximity data 932. The storage 918 may be connected to the environment 902 through a storage controller 914, which in turn may be connected to the chipset 906. In certain embodiments, the storage 918 may consist of one or more physical storage units. The storage controller 914 may interface with the physical storage units through various interfaces such as Serial Attached SCSI (“SAS”), Serial Advanced Technology Attachment (“SATA”), or Fiber Channel (“FC”), or other types of interfaces for physically connecting and transferring data between computers and physical storage units.

In many further embodiments, the device 900 may include a cloud fabric device onboarding logic 924. The cloud fabric device onboarding logic 924 may be a set of instructions stored within a non-volatile memory area of storage 918 or ROM 910 that, when executed by the processor(s) 904, can carry out various steps, processes, and operations related to device integration into a cloud-managed fabric. If the device 900 is a new network device seeking to join a fabric, the cloud fabric device onboarding logic 924 may be configured to query at least one adjacent switch using the NIC 912, analyze discovery protocol data, and initiate an authentication with a discovered fabric switch, potentially using a secure unique device identifier (SUDI) certificate. This cloud fabric device onboarding logic 924 may further enable the device 900 to exchange network proximity data, determine an optimal proxy path to a cloud controller if needed, transmit a connection request to the cloud controller via such a proxy, obtain an agent session token from the cloud controller, and subsequently establish a secure connection with the cloud controller for full integration.

Alternatively, if the device 900 is configured to act as a cloud controller or a component thereof, the cloud fabric device onboarding logic 924 may be configured to perform complementary operations. These may include receiving a proxied onboarding request for a new device from a gateway within the fabric, validating the authenticity of this onboarding request (which can involve authenticating the proxying gateway), and issuing an agent session token to the new device. The cloud fabric device onboarding logic 924 on such a device 900 may then receive a direct secure connection attempt from the new device that is associated with the issued agent session token, authenticate the new device based on this token, transmit necessary configuration data and security certificates to the new device, establish a management channel, and finally acknowledge the new device's full integration into the network fabric. Thus, the cloud fabric device onboarding logic 924 can encompass the intelligence for both a device joining the fabric and a controller managing the fabric onboarding process.

The storage 918 may also be configured to store communication data 928, which can be utilized by the cloud fabric device onboarding logic 924. In some embodiments, communication data 928 may include information related to discovery protocols, such as Link Layer Discovery Protocol (LLDP) information received from adjacent devices or MAC Organizationally Unique Identifiers (OUIs) that assist in identifying potential fabric switches. Furthermore, communication data 928 may store details of secure handshake exchanges, such as parameters for gRPC (Remote Procedure Call) communications over TLS used during authentication, parameters for IPv6 Link-Local Address communications with adjacent devices or proxies, or the contents of an obtained agent session token that authorizes further interactions with a cloud controller.

In additional embodiments, the storage 918 may contain configuration data 930. This configuration data 930 can represent operational parameters for the device 900, particularly after it has been successfully onboarded and integrated into the network fabric. For instance, configuration data 930 may include organization-specific policies pushed down from a cloud controller, security certificates necessary for secure communication within the fabric, general network settings such as IP addresses or VLAN assignments, Quality of Service (QoS) parameters, or settings specific to the device's designated role within the fabric, such as proxy agent configurations if the device 900 is to act as a proxy, or its unique identity within the managed fabric. The cloud fabric device onboarding logic 924 may apply or manage this data.

In further embodiments, the storage 918 may house proximity data 932. Proximity data 932 can store information gathered about the local network topology and the relationship of device 900 to other devices within the fabric, which can be critical for the cloud fabric device onboarding logic 924. For example, this data may include exchanged hop-count information detailing the logical distance to other discovered devices or gateways, learned details about the capabilities of adjacent switches (e.g., whether they can act as a proxy), or information about established paths to a cloud controller. The cloud fabric device onboarding logic 924 may utilize this proximity data 932 to make informed decisions, such as determining an optimal proxy path if direct cloud connectivity is unavailable or understanding its connectivity options within the fabric.

The device 900 may store data within the storage 918 by transforming the physical state of the physical storage units to reflect the information being stored. The specific transformation of physical state may depend on various factors. Examples of such factors may include, but are not limited to, the technology used to implement the physical storage units, whether the storage 918 is characterized as primary or secondary storage, and the like. In many more embodiments, the device 900 may store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 may further read or access information from the storage 918 by detecting the physical states or characteristics of one or more particular locations within the physical storage units.

In addition to the storage 918 described above, the device 900 may have access to other computer-readable storage media to store and retrieve information, such as program modules, data structures, or other data. It should be appreciated by those skilled in the art that computer-readable storage media is any available media that provides for the non-transitory storage of data and that may be accessed by the device 900. In some examples, operations performed by a cloud computing network, and/or any components included therein, may be supported by one or more devices similar to device 900. Stated otherwise, some or all of the operations performed by a cloud computing network, and/or any components included therein, may be performed by a device 900 or multiple operating in a cloud-based arrangement. By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage 918 may store an operating system 920 utilized to control the operation of the device 900. According to one embodiment, the operating system 920 comprises the LINUX operating system. According to another embodiment, the operating system 920 comprises the WINDOWS® SERVER operating system from MICROSOFT Corporation. According to further embodiments, the operating system 920 may comprise the UNIX operating system or one of its variants. It should be appreciated that other operating systems may also be utilized. The storage 918 may store other system or applications 922 and data utilized by the device 900. In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as applications 922, including the cloud fabric device onboarding logic 924, and transform the device 900 by specifying how the processor(s) 904 may transition between states, as described above.

In still further embodiments, the device 900 may also include one or more input/output controllers 916 for receiving and processing input from a number of input devices, such as a keyboard, a mouse, a touchpad, a touch screen, an electronic stylus, or other type of input device. Similarly, input/output controllers 916 may be configured to provide output to a display, such as a computer monitor, a flat panel display, a digital projector, a printer, or other type of output device. Those skilled in the art will recognize that the device 900 might not include all of the components shown in FIG. 9 and may include other components that are not explicitly shown in FIG. 9 or might utilize an architecture completely different than that shown in FIG. 9. As described above, the device 900 may support a virtualization layer, such as one or more virtual resources executing on the device 900. In some examples, the virtualization layer may be supported by a hypervisor that provides one or more virtual machines running on the device 900 to perform functions described herein.

In numerous additional embodiments, data stored in storage 918, such as the communication data 928, configuration data 930, and proximity data 932, may be processed into a format usable by one or more machine-learning models 926, potentially involving other pre-processing techniques. The one or more machine-learning models 926 may be any type of ML model, such as supervised models, reinforcement models, and/or unsupervised models, and may include one or more of linear regression models, logistic regression models, decision trees, Naïve Bayes models, neural networks, k-means cluster models, random forest models, and/or other types of ML models. The one or more machine-learning models 926 may be configured to generate inferences to make predictions or draw conclusions from this data. For instance, it might learn from patterns in communication data 928 and proximity data 932 to predict optimal proxy paths for new device onboarding or to identify anomalous onboarding behaviors. It could also analyze configuration data 930 over time across multiple devices to suggest optimized configurations or predict potential compatibility issues. The input data for the one or more machine-learning models 926 may be in various forms, and its output can also vary, potentially being a single number, a probability distribution, a set of labels, or a decision about an action to take regarding device onboarding or fabric management.

Although a specific embodiment for a device 900 suitable for configuration with a cloud fabric device onboarding logic 924 for carrying out the various steps, processes, methods, and operations described herein is discussed with respect to FIG. 9, any of a variety of systems and/or processes may be utilized in accordance with embodiments of the disclosure. For example, the device 900 may be implemented within a virtual environment, such as a component of a cloud-based network administration suite, or its functionalities, including the cloud fabric device onboarding logic 924, may be distributed across a variety of physical network devices or switches within a fabric. The elements depicted in FIG. 9 may also be interchangeable with other elements of prior FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network via a plurality of ports; and
a memory communicatively coupled to the processor, wherein the memory comprises a cloud fabric device onboarding logic that is configured to:
query at least one adjacent switch;
authenticate with a fabric switch;
exchange proximity data;
obtain an agent session token; and
establish a secure connection.

2. The device of claim 1, wherein the querying is initialized upon the device physically connecting to a network.

3. The device of claim 2, wherein an agent initializes the querying.

4. The device of claim 1, wherein the authentication can further include initiating a secure handshake.

5. The device of claim 1, wherein the authentication can utilize a secure unique device identifier certificate.

6. The device of claim 1, wherein the proximity data may comprise hop-count information.

7. The device of claim 1, wherein the agent session token is provided by a cloud controller.

8. The device of claim 7, wherein the secure connection is between the device and the cloud controller.

9. The device of claim 8, wherein establishing the secure connection is achieved via the agent session token.

10. The device of claim 9, wherein the secure connection is a direct secure communication channel.

11. The device of claim 9, wherein the secure connection is a continually proxied secure connection.

12. A method of dynamically joining a cloud-managed network fabric, the method comprising:
querying at least one adjacent switch;
authenticating with a fabric switch;
exchanging network proximity data;
obtaining an agent session token from a cloud controller; and
establishing a secure connection with the cloud controller.

13. The method of claim 12, wherein the method further includes identifying a fabric switch prior to authenticating with the fabric switch.

14. The method of claim 13, wherein the method further includes authenticating with the fabric switch prior to exchanging network proximity data.

15. The method of claim 14, wherein the method further includes determining an optimal proxy path to a cloud controller prior to obtaining an agent session token from the cloud controller.

16. The method of claim 15, wherein the method further includes transmitting a cloud controller connection request via the optimal proxy path.

17. The method of claim 16, wherein the method further includes obtaining an initial connection upon obtaining an agent session token.

18. The method of claim 17, wherein the method further comprises receiving, upon obtaining the initial connection, configuration data from a cloud controller.

19. A cloud controller within a network fabric, comprising:
a processor;
at least one network interface controller configured to provide access to the network fabric via a plurality of ports; and
a memory communicatively coupled to the processor, wherein the memory comprises a cloud fabric device onboarding logic that is configured to:
receive a proxied onboarding request wherein the proxied onboarding request is associated with an authenticity;
validate the authenticity of the proxied onboarding request;
issue an agent session token;
receive a direct secure connection attempt associated with the agent session token;
authenticate a new device associated with the proxied onboarding request;
transmit configuration data; and
acknowledge full integration into the network fabric.

20. The cloud controller of claim 19, wherein the cloud fabric device onboarding logic further comprises establishing a management channel prior to acknowledging full integration into the network fabric.
